(19) United States
(12) Patent Application Publication
(10) Pub. No.: US 2008/0174821 A1
(43) Pub. Date: Jul. 24, 2008

(54) SYSTEM AND METHOD FOR CUSTOM BRANDING OF DOCUMENT PROCESSING DEVICES

(76) Inventors: Harpreet Singh, Orange, CA (US); Marianne Kodimer, Huntington Beach, CA (US); Brenda Daos, Mission Viejo, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/626,824

(22) Filed: Jan. 24, 2007

(51) Int. Cl. G06F 15/00

(52) U.S. Cl. 358/1.16

(57) ABSTRACT

The subject application is directed to a system and method for custom branding of document processing devices. Image data representing a branding identifier image is first received. The image data corresponding to the branding identifier image is then stored in a memory associated with a document processing device. The branding identifier image data is then communicated from the memory to a user interface associated with the document processing device. The branding identifier image is then generated on the display of the user interface concurrently with the display of image data representing document processing operations capable of being performed by the associated document processing device.

### BACKGROUND OF THE INVENTION

The subject application is directed to a system and method for custom branding of document processing devices. More particularly, the subject application is directed to a system and method with the ability for users of office machines to customize interfaces of document processing devices to incorporate branding information, or other custom display information.

Most modern businesses rely on office machinery, including document processing devices, in their day to day operations. Some businesses will purchase machines outright for use by employees, while others may lease machinery or subcontract installation and maintenance of such machinery.

Document processing devices, such as scanners, copiers, printers, facsimile machines, or multi-function peripherals that include two or more of such functions, typically include a user interface. Such interfaces included touch screen panels, keyboard controls, number pad controls, or point-and-click interfaces. Most users will rely on the default interfaces supplied by a manufacturer of such a device. While some large companies or third party office machine suppliers may customize interfaces, most companies do not have the sophistication or resources do so.

### SUMMARY OF THE INVENTION

In accordance with one embodiment of the subject application, there is provided a system and method for custom branding of document processing devices.

Further, in accordance with one embodiment of the subject application, there is provided a system and method with the ability for users of office machines to customize interfaces of document processing devices to incorporate branding information, or other custom display information.

Still further, in accordance with one embodiment of the subject application, there is provided a system and method for customizing a display easily, and through a thin client interface.

Still further, in accordance with one embodiment of the subject application, there is provided a system and method that allows for verification of acceptability of custom display information on a document processing device interface.

Still further, in accordance with one embodiment of the subject application, there is provided a system and method that allows for concurrent display of custom display information with information relating to operation of the device.

Further, in accordance with one embodiment of the subject application, there is provided a system for custom branding of document processing devices. The system includes input means adapted for receiving image data representative of a branding identifier image and a memory associated with a document processing device adapted for storing received image data. The system also includes means adapted for communicating image data from the memory to a user interface associated with the document processing device and means adapted for generating an image corresponding to the image data on a specified display area of the user interface concurrently with image data corresponding to operation of the document processing device.

In one embodiment of the subject application, the system further includes a thin client interface in data communication with the input means via an associated network and means adapted for receiving login data via the thin client interface. In this embodiment, the system also includes verification means adapted for testing received login data to determine an authority level of an associated user and means adapted for selectively generating a prompt on the thin client interface corresponding to an input of image data in accordance with an output of the testing means.

In another embodiment of the subject application, the system also includes testing means adapted for testing received image data for compatibility relative to the specified display area.

In yet another embodiment of the subject application, the system also comprises means adapted for generating a compatibility display on the thin client interface representative of compatibility of received image data in accordance with an output of the testing means.

In a further embodiment of the subject application, the compatibility display includes property data associated with received image data and data representative of preselected acceptability standards associated with the specified display area.

In yet another embodiment of the subject application, the compatibility display includes data representative of at least one property from the group consisting of image size, data size, and color palette.

Still further, in accordance with one embodiment of the subject application, there is provided a method for custom branding of document processing devices in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the system for custom branding of document processing devices according to one embodiment of the subject application;

FIG. 2 is a block diagram illustrating device hardware for use in the system for custom branding of document processing devices according to one embodiment of the subject application;

FIG. 3 is a functional diagram illustrating the device for use in the system for custom branding of document processing devices according to one embodiment of the subject application;

FIG. 4 is a block diagram illustrating controller hardware for use in the system for custom branding of document processing devices according to one embodiment of the subject application;

FIG. 5 is a functional diagram illustrating the controller for use in the system for custom branding of document processing devices according to one embodiment of the subject application;

FIG. 6 is a flowchart illustrating a method for custom branding of document processing devices according to one embodiment of the subject application;

FIG. 7 is a flowchart illustrating a method for custom branding of document processing devices according to one embodiment of the subject application; and

FIG. 8 is an example implementation of the concurrent display of branding identifier image data and document processing operations image data according to one embodiment of the subject application.

### DETAILED DESCRIPTION OF THE PREFERRED EMBODIMENT

The subject application is directed to a system and method for custom branding of document processing devices. In one particular embodiment, the subject application is directed to a system and method with the ability for users of office machines to customize interfaces of document processing devices to incorporate branding information, or other custom display information. More particularly, one embodiment of the subject application is directed to a system and method for customizing a display easily, and through a thin client interface. In particular, one embodiment of the subject application is directed to a system and method that allows for verification of acceptability of custom display information on a document processing device interface. Still further, one embodiment of the subject application is directed to a system and method that allows for concurrent display of custom display information with information relating to operation of the device.

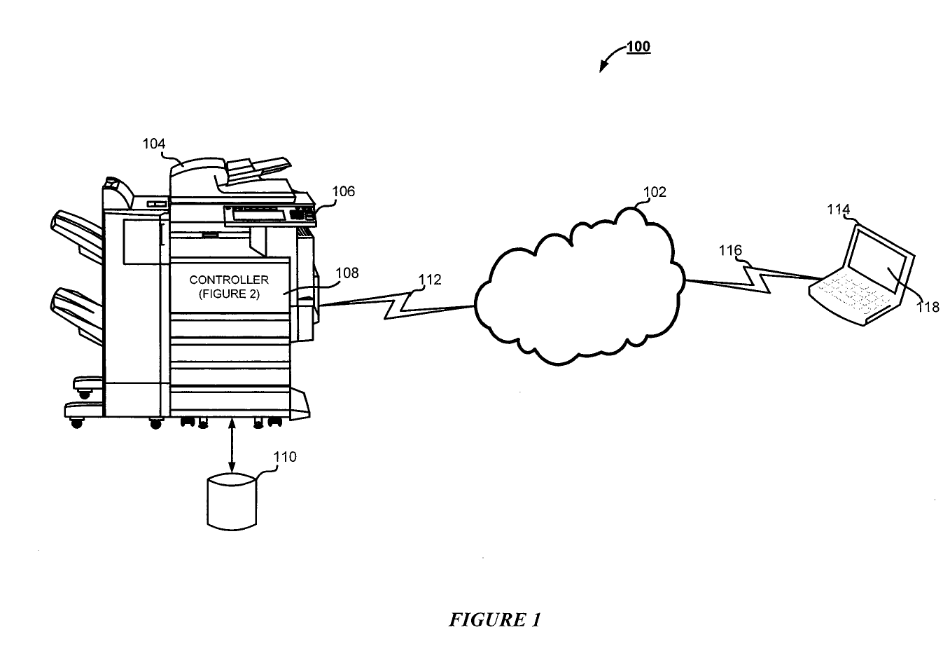

It will become apparent to those skilled in the art that the system and method described herein are suitably adapted to a plurality of varying electronic fields employing user interfaces, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of the system 100 for custom branding of document processing devices in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

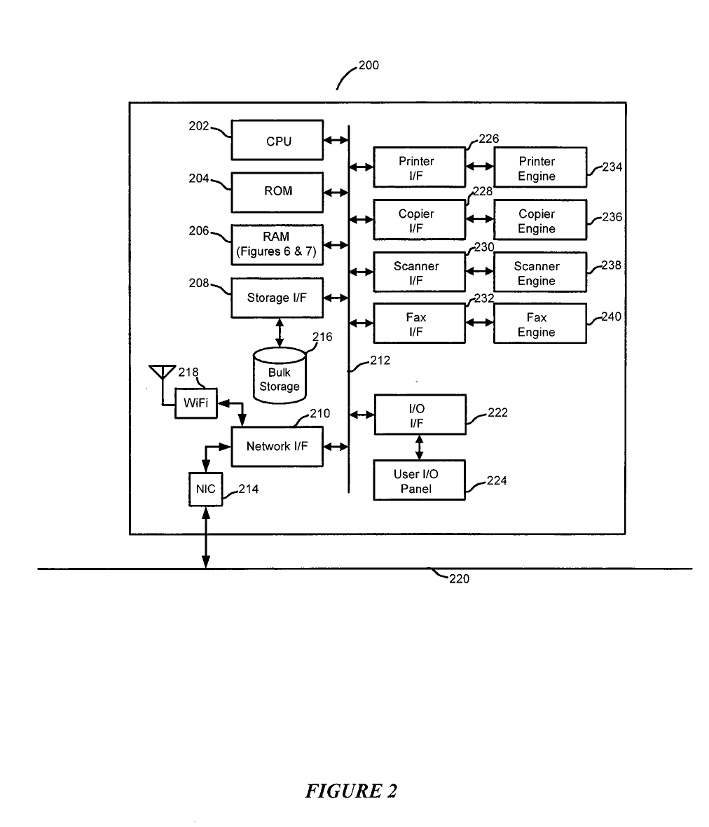

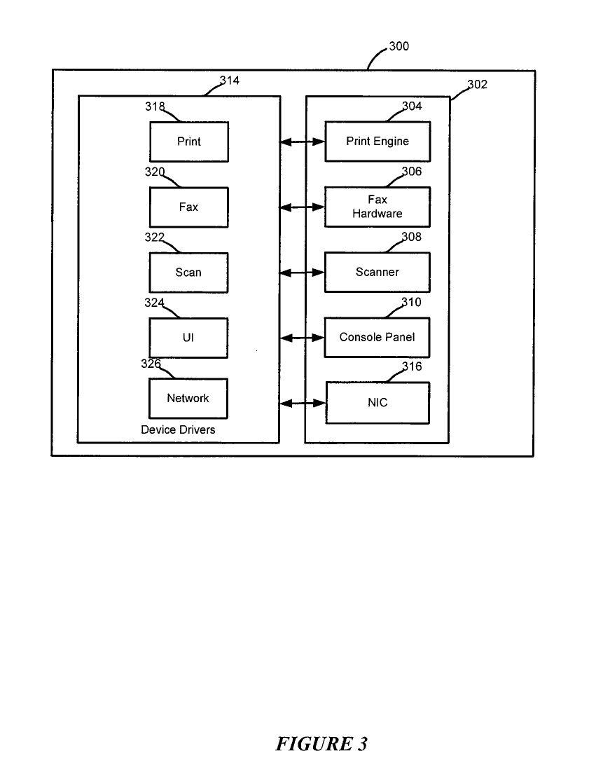

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. The functioning of the document processing device 104 will better be understood in conjunction with the diagrams illustrated in FIG. 2 and FIG. 3, discussed in greater detail below.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

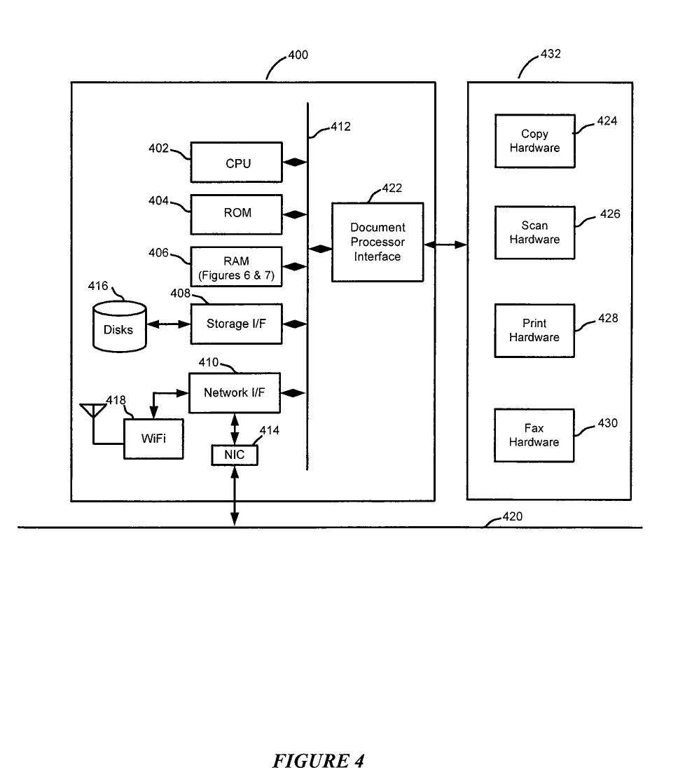

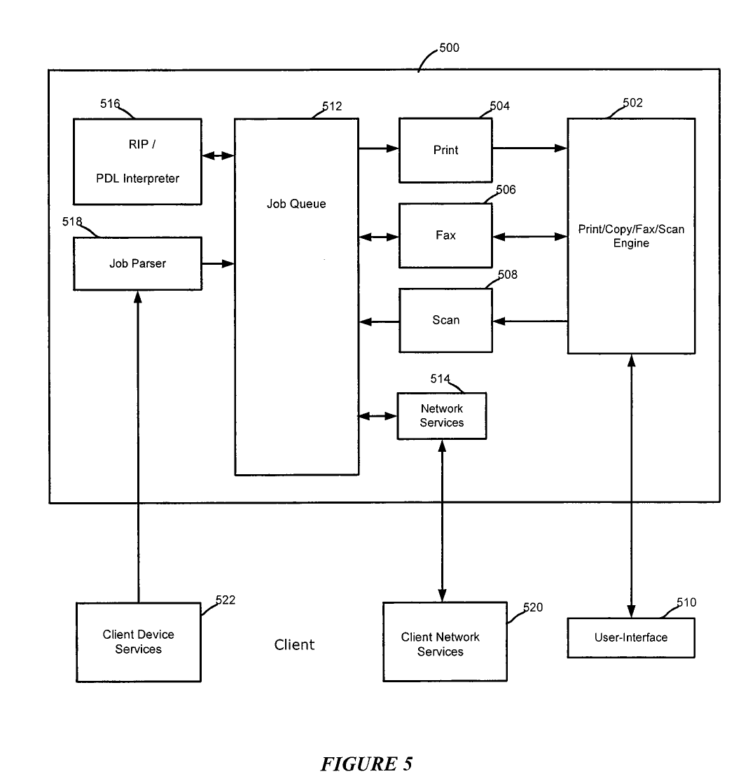

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for custom branding of document processing devices according to the subject application. The functioning of the controller 108 will better be understood in conjunction with the block diagrams illustrated in FIGS. 4 and 5, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like. In accordance with one embodiment of the subject application, the data storage device 110 includes branding identifier image data, display property data, and the like.

The system 100 illustrated in FIG. 1 further depicts a user device 114, in data communication with the computer network 102 via a communications link 116. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102.

In accordance with one embodiment of the subject application, the user device 114 further comprises a thin client interface 118, suitably adapted to communicate with the document processing device 104 via the computer network 102. As will be understood by those skilled in the art, suitable thin client interfaces include, for example and without limitation, a web-browser, a dedicated network application, a suitable software application, or any suitable combination thereof. According to one embodiment of the subject application, the thin client interface 118 is capable of enabling an associated user to adjust the display properties of the user interface 106 associated with the document processing device 104. Preferably, the thin client interface 118 is also capable of graphically presenting the display of the user interface 106 so as to enable the associated user to view graphical elements as displayed on the user interface 106.

Turning now to FIG. 2, illustrated is a representative architecture of a suitable device 200 on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the server 200.

Also included in the server 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 108 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with bus the 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image processor, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The Parser 518 functions to interpret a received electronic document file and relay it to the job queue 512 for handling in connection with the afore-described functionality and components.

In operation, image data representing a branding identifier image is first received. This branding identifier image data is then stored in memory associated with the document processing device 104. Image data from memory is then communicated to the user interface 106 associated with the document processing device 104. An image corresponding to the image data is then generated on a specified display area of the user interface 106 concurrently with image data corresponding to operations of the document processing device 104.

In accordance with one example embodiment of the subject application, login data is received by the controller 108 or other suitable component associated with the document processing device 104 from a thin client interface 118. Preferably, the thin client interface 118 is resident on a user device 114 in data communication with the document processing device 104 via the computer network 102. It will be understood by the skilled artisan that the thin client 118 is capable of residing on the user interface 106 associated with the document processing device 104, whereupon the user interface 106 receives the user login data directly from the user. As will be appreciated by those skilled in the art, the login data corresponds to the identity and associated authority of a user, including, for example and without limitation, a username and/or password, biometric data, alphanumeric sequence, or the like. In accordance with one embodiment of the subject application, the thin client 120 suitably comprises a web-portal, web browser, network application, local software application, or any combination thereof, adapted to send and receive data communications with the document processing device 104 via the computer network 102. Preferably, the thin client interface 118 is capable of implementing secure data communications via any suitable security protocols known in the art.

The received login data is then tested by the controller 108, or other suitable component of the document processing device 104 to determine the level of authority associated with the user. That is, a determination is made as to the rights of the user with respect to modifying the document processing device 104. It will be understood by those skilled in the art that the subject application is capable of implementing an authentication server (not shown), suitably adapted to verify and authenticate a user. Thus, the skilled artisan will appreciate that the use of an authentication server enables the document processing device 104 to focus on document processing operations and not use processing capacity for authentication operations.

Once the user associated with the login data is tested, i.e., authenticated, a prompt to input image data is selectively generated on the thin client interface 118, based upon the result of the testing of the login data. That is, the user is prompted via the thin client interface 118 to input an image that the user desires to have displayed on the user interface 106 associated with the document processing device 104. For example, the user is capable of uploading a branding identifier image corresponding to a service provider, a company logo, a manufacturer logo, or the like. The skilled artisan will appreciate that other images are capable of being uploaded in accordance with the system and method of the subject application. When the user does not provide suitable login data, e.g., the user is not authorized to upload images to the document processing device 104, the user is denied access via the thin client interface 118. The controller 108 or other suitable component associated with the document processing device 104 then receives the branding identifier image data and tests the received image data for compatibility relative to the display associated with the user interface 106. When the received image data is not compatible with the display, the user is prompted to select new image data via the thin client interface 118. A compatibility display is then generated on the thin client interface 118 representing the compatibility of the image data received by the controller 108 according to the compatibility testing. In accordance with one embodiment of the subject application, the compatibility display further includes, for example and without limitation, property data associated with the received image data, data representing preselected acceptability standards associated with the specified display area, or the like. Preferably, the property data includes image size, data size, color palette, image orientation, or the like. The skilled artisan will appreciate that the property data enables the administrative user to preselect where on the display the image data will be displayed to the user, edit existing images, or the like.

The controller 108, or other component of the document processing device 104, then stores the compatible received image data in the associated data storage device 110 for further use. That is, the image data is stored on the data storage device 110 and used for the generation of the branding identifier image on the display of the user interface 106. Preferably, the branding identifier image is generated on the display concurrently with the display of one or more document processing operations capable of being performed by the document processing device 104.

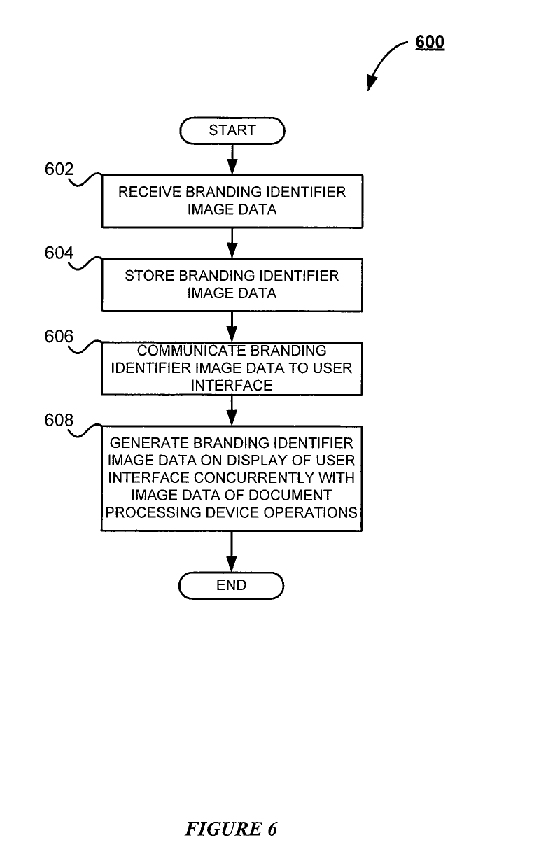

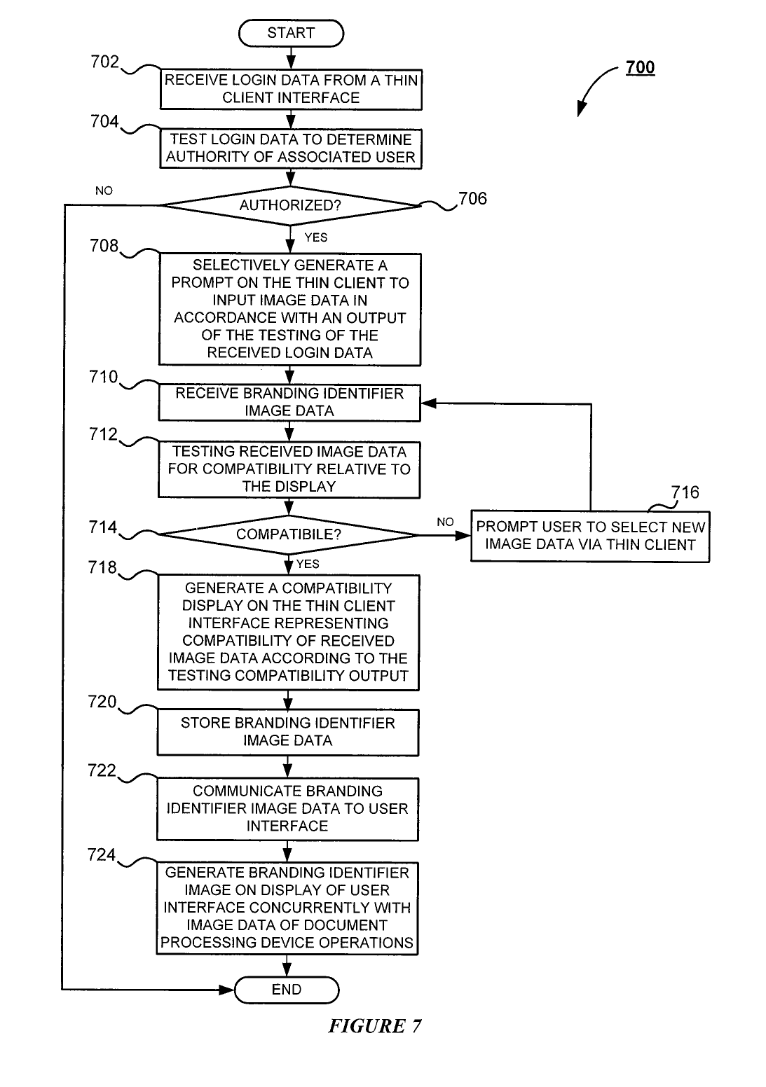

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7. Turning now to FIG. 6, there is shown a flowchart 600 illustrating a method for custom branding of document processing devices in accordance with one embodiment of the subject application. Beginning at step 602, image data representing a branding identifier image is received via a suitable means. The received image data, corresponding to the branding identifier image is then stored in a memory associated with the document processing device 104 at step 604. In accordance with one embodiment of the subject application, the image data is stored in the data storage device 110 associated with the document processing device 104.

The branding identifier image data is then communicated from the memory to a user interface 106 associated with the document processing device 104 at step 606. It will be appreciated by those skilled in the art that the image data is capable of functioning as a background for the user interface 106, a preselected portion of the display of the user interface 106, a suitable screensaver on the display of the user interface 106, or the like. Branding identifier image data is then generated on the display of the user interface 106 at step 608 concurrently with the display of image data representing document processing operations capable of being performed by the associated document processing device 104.

Referring now to FIG. 7, there is shown a flowchart 700 illustrating a method for custom branding of document processing devices in accordance with one embodiment of the subject application. The method depicted in FIG. 7 begins at step 702, whereupon login data is received by the controller 108 or other suitable component of the document processing device 104 from a thin client interface 118. In accordance with one embodiment of the subject application, the thin client interface 118 is representative of a web browser, web-based application, software application, or the like, resident on the user device 114 and capable of interacting with the document processing device 104 via the computer network 102. The login data received by the controller 108 is then tested at step 704 to determine the authority of the user associated with the login data. That is, the controller 108 or other component of the document processing device 104 determines whether the user is authorized to upload images and/or make changes to the display associated with the user interface 106 of the document processing device. As will be appreciated by those skilled in the art, the subject application is capable of implementing a secondary or tertiary authentication step, employing a suitable authentication server (not shown) or the like, suitably adapted to verify and authenticate a user, thereby allowing the document processing device 104 to focus on document processing operations and not use processing capacity for authentication operations.

A determination is then made at step 706 whether the user has the appropriate authority to make such changes to the display. When the login data does not indicate the appropriate level of authority, the operation described in FIG. 7 terminates, as the user lacks the rights to make changes to the display associated with the user interface 106 of the document processing device 104. When the appropriate level of authority is determined based upon the testing at step 706, flow progresses to step 708, wherein a prompt is generated on the thin client interface 118 to input image data. That is, a prompt is selectively generated on the thin client interface 118 to select an image to upload to the document processing device 104 based upon the output of the testing performed on the received login data. Preferably, the user selects a branding identifier image via the prompt, which is received at step 710 by the controller 108 associated with the document processing device 104 via the computer network 102.

The received branding image data is then tested for compatibility relative to the display of the user interface 106 at step 712. That is, the controller 108 or other suitable component associated with the document processing device 104 tests the received image to determine whether the image size, color, orientation, file size, file type, or the like, meet preselected property requirements or limitations associated with the user interface 106. For example, when the image is too large to be accurately displayed on the display, or requires colors and the display is monochromatic, or the like, the image is therefore not compatible with the user interface 106. When it is determined at step 714 that the received image data is not compatible, flow proceeds to step 716, whereupon the user is prompted via the thin client 120 to select new image data for uploading to the display of the user interface 106 associated with the document processing device. 104. Thereafter, flow return to step 710, whereupon the new image is received by the controller 108 and operations continue thereon as set forth above.

When the image received by the controller 108 is determined to be compatible with the display of the user interface 106, flow proceeds to step 718, whereupon a compatibility display is generated on the thin client interface 118. Preferably, the compatibility display is representative of the compatibility of the received image data with the user interface 106 based upon the outcome of the testing. The image data, or branding identifier image, is then stored in memory, e.g., the data storage device 110, at step 720. The branding identifier image is then communicated from the data storage device 110 to the user interface 106 at step 722. The user interface 106 then generates the branding identifier image on the display at step 724 concurrently with displaying graphical representations of document processing operations capable of being performed by the document processing device 104. The skilled artisan will therefore appreciate that the subject application is capable of adding, modifying, or deleting a corporate logo, image, company information, advertisement, or the like on the display of the user interface 106. Furthermore, the skilled artisan will appreciate that the image is capable of being displayed concurrently with document processing operation icons on the user interface 106.

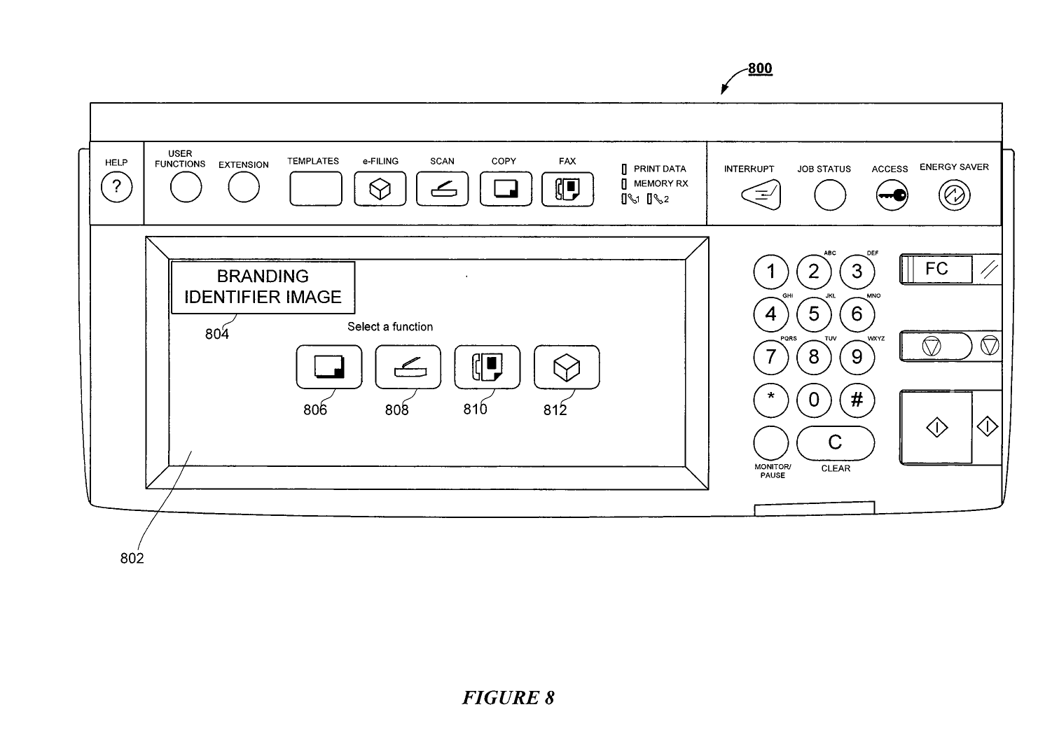

Turning now to FIG. 8, there is shown an example implementation of the concurrent display of branding identifier image data and document processing operations image data in accordance with one embodiment of the subject application. The user interface 800 of FIG. 8 includes a display 802 capable of graphically communicating data to an associated user and receive instructions from the user. Preferably, the display 802 is a touch-screen display, as are known in the art, capable of receiving input from a user via the user depressing a corresponding portion of the screen. In this example of a suitable user interface 800, the display 802 includes a branding identifier image 804 in the upper left corner of the associated display 802. It will be appreciated by those skilled in the art that the position and the size of the branding identifier image 804 is for illustration purposes only, and the subject application is capable of implementing any preselected size and/or location of the branding identifier image 804 as determined by a suitable administrator. Thus, for example and without limitation, the image 804 is capable of representing a background image, over which other images are displayed. In accordance with one embodiment of the subject application, the user interface 800 display 802 further includes a plurality of icons 806, 808, 810, and 812 representative of document processing operations capable of being performed by the associated document processing device 104. As shown in FIG. 8, suitable operation icons include, for example and without limitation, a copy icon 806, a scan icon 808, a facsimile icon 810, and a forms icon 812. The skilled artisan will appreciate that any other operation capable of being performed by the associated document processing device 104 is also capable of being displayed in accordance with the subject application. Of importance is that the operation icons 806-812 and the branding identifier image 804 are displayed concurrently on the user interface 800 in accordance with the subject application.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for custom branding of document processing devices comprising:
input means adapted for receiving image data representative of a branding identifier image;
a memory associated with a document processing device adapted for storing received image data;
means adapted for communicating image data from the memory to a user interface associated with the document processing device; and
means adapted for generating an image corresponding to the image data on a specified display area of the user interface concurrently with image data corresponding to operation of the document processing device.

2. The system for custom branding of document processing device of claim 1 further comprising:
a thin client interface in data communication with the input means via an associated network;
means adapted for receiving login data via the thin client interface;
verification means adapted for testing received login data to determine an authority level of an associated user; and
means adapted for selectively generating a prompt on the thin client interface corresponding to an input of image data in accordance with an output of the testing means.

3. The system for custom branding of document processing device of claim 2 further comprising testing means adapted for testing received image data for compatibility relative to the specified display area.

4. The system for custom branding of document processing device of claim 3 further comprising means adapted for generating a compatibility display on the thin client interface representative of compatibility of received image data in accordance with an output of the testing means.

5. The system for custom branding of document processing device of claim 4 wherein the compatibility display includes property data associated with received image data and data representative of preselected acceptability standards associated with the specified display area.

6. The system for custom branding of document processing device of claim 5 wherein the compatibility display includes data representative of at least one property from the group consisting of image size, data size, and color palette.

7. A method for custom branding of document processing devices comprising the steps of:
receiving image data representative of a branding identifier image;
storing received image data in a memory associated with a document processing device;
communicating image data from the memory to a user interface associated with the document processing device; and
generating an image corresponding to the image data on a specified display area of the user interface concurrently with image data corresponding to operation of the document processing device.

8. The method for custom branding of document processing device of claim 7 further comprising the steps:
receiving login data via a thin client interface;
testing received login data to determine an authority level of an associated user; and
selectively generating a prompt on the thin client interface corresponding to an input of image data in accordance with an output of the testing of the received login data.

9. The method for custom branding of document processing device of claim 8 further comprising the step of testing received image data for compatibility relative to the specified display area.

10. The method for custom branding of document processing device of claim 9 further comprising the step of generating a compatibility display on the thin client interface representative of compatibility of received image data in accordance with an output of the testing of compatibility.

11. The method for custom branding of document processing device of claim 10 wherein the compatibility display includes property data associated with received image data and data representative of preselected acceptability standards associated with the specified display area.

12. The method for custom branding of document processing device of claim 11 wherein the compatibility display includes data representative of at least one property from the group consisting of image size, data size, and color palette.

13. A computer-implemented method for custom branding of document processing devices comprising the steps of:
receiving image data representative of a branding identifier image;
storing received image data in a memory associated with a document processing device;
communicating image data from the memory to a user interface associated with the document processing device; and
generating an image corresponding to the image data on a specified display area of the user interface concurrently with image data corresponding to operation of the document processing device.

14. The computer-implemented method for custom branding of document processing device of claim 13 further comprising the steps:
receiving login data via a thin client interface;
testing received login data to determine an authority level of an associated user; and
selectively generating a prompt on the thin client interface corresponding to an input of image data in accordance with an output of the testing of the received login data.

15. The computer-implemented method for custom branding of document processing device of claim 14 further comprising the step of testing received image data for compatibility relative to the specified display area.

16. The computer-implemented method for custom branding of document processing device of claim 15 further comprising the step of generating a compatibility display on the thin client interface representative of compatibility of received image data in accordance with an output of the testing of compatibility.

17. The computer-implemented method for custom branding of document processing device of claim 16 wherein the compatibility display includes property data associated with received image data and data representative of preselected acceptability standards associated with the specified display area.

18. The computer-implemented method for custom branding of document processing device of claim 17 wherein the compatibility display includes data representative of at least one property from the group consisting of image size, data size, and color palette.
